(19) United States
(12) Patent Application Publication
(10) Pub. No.: US 2019/0354178 A1
(43) Pub. Date: Nov. 21, 2019

(54) ARTIFICIAL INTELLIGENCE DEVICE CAPABLE OF BEING CONTROLLED ACCORDING TO USER ACTION AND METHOD OF OPERATING THE SAME

(71) Applicant: LG ELECTRONICS INC., Seoul (KR)

(72) Inventor: Taeju Hwang, Seoul (KR)

(73) Assignee: LG ELECTRONICS INC., Seoul (KR)

(21) Appl. No.: 16/526,605

(22) Filed: Jul. 30, 2019

(30) Foreign Application Priority Data
Jun. 28, 2019 (KR) 10-2019-0077803

(51) Int. Cl. G06F 3/01; H04N 21/442; H04N 21/422; H04N 21/4223

(52) U.S. Cl. CPC G06F 3/013; G06F 3/017; H04N 21/4223; H04N 21/42203; H04N 21/44218

(57) ABSTRACT

An artificial intelligence device capable of being controlled according to user action includes a display, a camera configured to capture an image of a user, and a processor configured to acquire first user action information based on the captured image, change an operation state of the artificial intelligence device from an inactive state to an active state when the acquired first user action information is predetermined action information, display a cursor at a position corresponding to a gaze of the user through the display based on the captured image, acquire second user action information, and select an item corresponding to the position of the cursor based on the acquired second user action information.

### BACKGROUND

The present invention relates to an artificial intelligence device capable of being controlled according to user action and a method of operating the same.

Competition for voice recognition technology which has started in smartphones is expected to become fiercer in the home with diffusion of the Internet of things (IoT).

In particular, an artificial intelligence (AI) device capable of issuing a command using voice and having a talk is noteworthy.

A voice recognition service has a structure for selecting an optimal answer to a user's question using a vast amount of database.

A voice search function refers to a method of converting input voice data into text in a cloud server, analyzing the text and retransmitting a real-time search result to a device.

The cloud server has a computing capability capable of dividing a large number of words into voice data according to gender, age and intonation and storing and processing the voice data in real time.

As more voice data is accumulated, voice recognition will be accurate, thereby achieving human parity.

An environment in which the AI device can provide a voice recognition service needs to be provided.

For example, when operation is not confirmed by a voice command due to a lot of ambient noise or when a user cannot issue a voice command, a voice recognition service cannot be provided.

### SUMMARY

An object of the present invention is to control operation of an artificial intelligence (AI) device using various user actions.

Another object of the present invention is to select an AI device to be controlled through action such as a user's gaze, gesture or eyeblink when a user cannot issue a voice command and to control operation of the selected AI device.

An artificial intelligence device capable of being controlled according to user action includes a display, a camera configured to capture an image of a user, and a processor configured to acquire first user action information based on the captured image, change an operation state of the artificial intelligence device from an inactive state to an active state when the acquired first user action information is predetermined action information, display a cursor at a position corresponding to a gaze of the user through the display based on the captured image, acquire second user action information, and select an item corresponding to the position of the cursor based on the acquired second user action information.

### BRIEF DESCRIPTION OF THE DRAWINGS

FIG. 1 is a view showing an artificial intelligence (AI) device according to an embodiment of the present invention.

FIG. 2 is a view showing an AI server according to an embodiment of the present invention.

FIG. 3 is a view showing an AI system according to an embodiment of the present invention.

FIG. 4 is a view showing an artificial intelligence (AI) device according to another embodiment of the present invention.

FIG. 5 is a flowchart illustrating a method of operating an AI device according to an embodiment of the present invention.

FIGS. 6 and 7 are views illustrating a process of grasping movement of a user's gaze at an AI device and changing an operation state of the AI device according to an embodiment of the present invention.

FIGS. 8 to 11 are views illustrating an example of selecting an item corresponding to a cursor according to second user action information according to an embodiment of the present invention.

FIG. 12 is a flowchart illustrating a method of operating an AI device according to another embodiment of the present invention.

FIGS. 13 and 14 are views illustrating an example of controlling movement of a cursor according to movement of a user's finger.

### DETAILED DESCRIPTION OF THE EMBODIMENTS

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

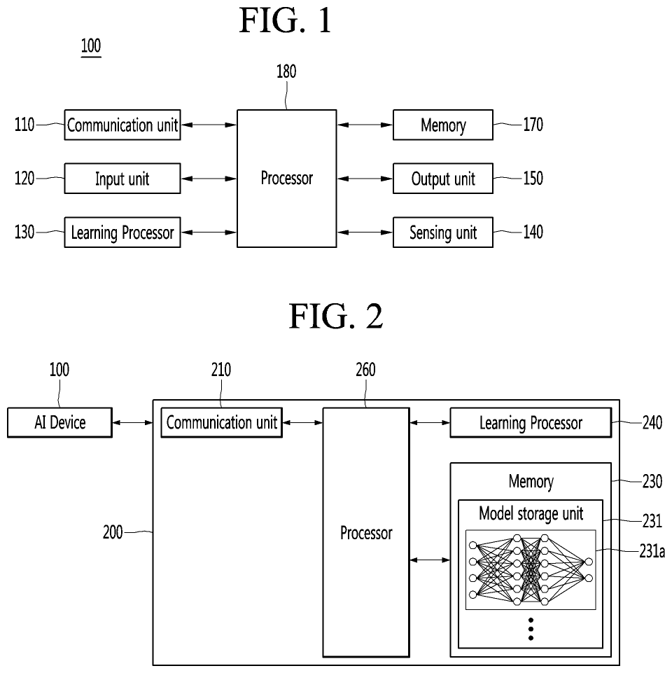

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (SIB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

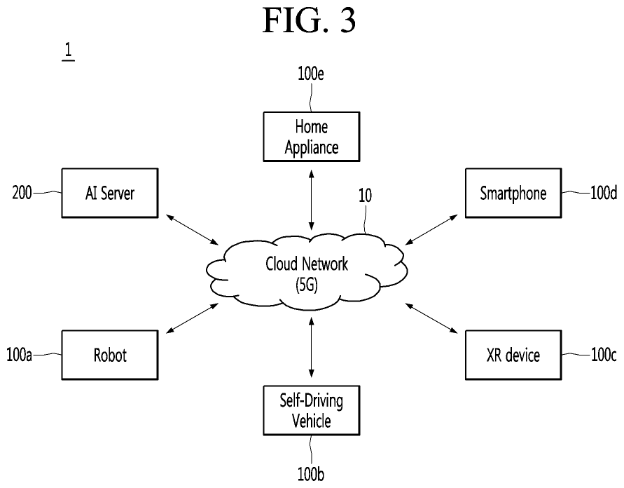

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

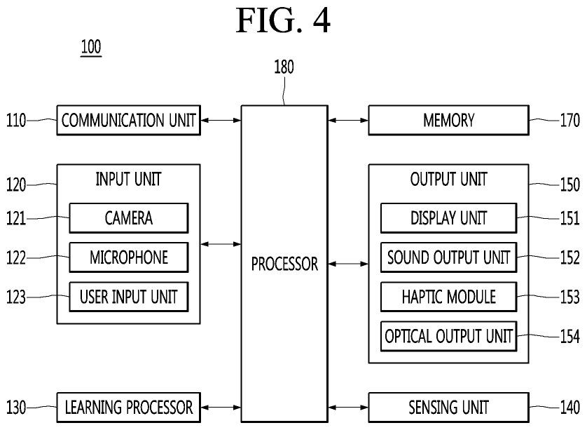

FIG. 4 shows an AI device 100 according to an embodiment of the present invention.

A repeated description of FIG. 1 will be omitted.

Referring to FIG. 4, an input unit 120 may include a camera 121 for receiving a video signal, a microphone 122 for receiving an audio signal and a user input unit 123 for receiving information from a user.

Audio data or image data collected by the input unit 120 may be analyzed and processed as a control command of the user.

The input unit 120 receives video information (or signal), audio information (or signal), data or information received from the user, and the AI device 100 may include one or a plurality of cameras 121 for input of the video information.

The camera 121 processes an image frame such as a still image or a moving image obtained by an image sensor in a video call mode or a shooting mode. The processed image frame may be displayed on a display unit 151 or stored in a memory 170.

The microphone 122 processes external acoustic signals into electrical sound data. The processed sound data may be variously utilized according to the function (or the application program) performed in the AI device 100. Meanwhile, various noise removal algorithms for removing noise generated in a process of receiving the external acoustic signal is applicable to the microphone 122.

The user input unit 123 receives information from the user. When information is received through the user input unit 123, a processor 180 may control operation of the AI device 100 in correspondence with the input information.

The user input unit 123 may include a mechanical input element (or a mechanical key, for example, a button located on a front/rear surface or a side surface of the terminal 100, a dome switch, a jog wheel, a jog switch, and the like) and a touch input element. As one example, the touch input element may be a virtual key, a soft key or a visual key, which is displayed on a touchscreen through software processing, or a touch key located at a portion other than the touchscreen.

An output unit 150 may include at least one of a display unit 151, a sound output unit 152, a haptic module 153, and an optical output unit 154.

The display unit 151 displays (outputs) information processed in the AI device 100. For example, the display unit 151 may display execution screen information of an application program executing at the AI device 100 or user interface (UI) and graphical user interface (GUI) information according to the execution screen information.

The display unit 151 may have an inter-layered structure or an integrated structure with a touch sensor so as to implement a touchscreen. The touchscreen may provide an output interface between the terminal 100 and a user, as well as functioning as the user input unit 123 which provides an input interface between the AI device 100 and the user.

The sound output unit 152 may output audio data received from a communication unit 110 or stored in the memory 170 in a call signal reception mode, a call mode, a record mode, a voice recognition mode, a broadcast reception mode, and the like.

The sound output unit 152 may include at least one of a receiver, a speaker, a buzzer or the like.

The haptic module 153 may generate various tactile effects that can be felt by a user. A representative example of tactile effect generated by the haptic module 153 may be vibration.

The optical output unit 154 may output a signal indicating event generation using light of a light source of the AI device 100. Examples of events generated in the AI device 100 may include a message reception, a call signal reception, a missed call, an alarm, a schedule notice, an email reception, an information reception through an application, and the like.

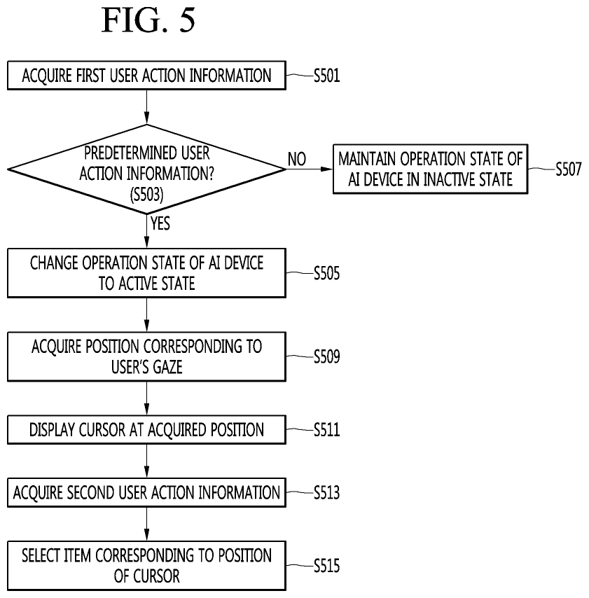

FIG. 5 is a flowchart illustrating a method of operating an AI device according to an embodiment of the present invention.

In particular, FIG. 5 relates to a method of recognizing user actions and controlling operation of the AI device.

In FIG. 5, the operation state of the AI device 100 may include an inactive state and an active state.

The inactive state of the AI device 100 may be an unawakened state incapable of performing operation corresponding to a user command. The user command may be any one of a voice command and a gesture command.

The active state of the AI device 100 may be an awake state capable of performing operation corresponding to a user command. The AI device 100 may receive the user command and perform operation according to the received command, in the active state.

Meanwhile, the following embodiment may be implemented in a situation in which a user cannot use a voice recognition service through the AI device 100. The situation in which the user cannot use the voice recognition service through the AI device 100 may be any one of a situation in which there is a lot of ambient noise, a situation in which the microphone 122 of the AI device 100 is broken, and a situation in which the user has to keep silent.

The AI device 100 may measure ambient noise through the microphone 122 and output a notification indicating that provision of the voice recognition service is impossible through the output unit 150 when the intensity of ambient noise is equal to or greater than a reference intensity.

The AI device 100 may output a guide indicating that operation of the AI device 100 is possible according to user action (gaze, eyeblink and hand movement) through the output unit 150 while outputting the notification indicating that provision of the voice recognition service is impossible.

Referring to FIG. 5, the processor 180 of the AI device 100 acquires first user action information through the camera 121 (S501).

The processor 180 may detect whether the user approaches the AI device using a proximity sensor or an infrared sensor provided in the sensing unit 140.

The processor 180 may drive the camera 121 upon determining that the user has approached the AI device 100.

The processor 180 may acquire a user image through the camera 121 and extract an eye image from the acquired user image. The acquired user image may be a moving image or a still image.

The processor 180 may grasp movement of the user's gaze from the extracted eye image. The processor 180 may acquire the gaze position to which the left pupil or the right pupil of the left eye image included in the extracted eye image is directed.

Thereafter, the processor 180 may determine whether the gaze position moves and acquire movement of the gaze position as first user action information.

That is, the first user action information may include information on movement of the user's gaze.

In another example, the first user action information may be information on a specific user gesture.

The processor 180 determines whether the acquired first user action information is predetermined user action information (S503).

The processor 180 may compare the first user action information with user action information prestored in the memory 170.

The predetermined user action information may be information stored according to user settings or information set by default.

The memory 170 may store a predetermined gaze movement pattern used to change the operation state of the AI device 100 from the inactive state to the active state.

The processor 180 may determine the first user action information as predetermined user action information when the movement of the acquired user's gaze matches the prestored gaze movement pattern.

The processor 180 changes the operation state of the AI device 100 to the active state, when the first user action information is the predetermined user action information (S505).

That is, the processor 180 may recognize the first user action information to be equal to a startup command of the user and change the operation state of the AI device 100 from the inactive state to the active state.

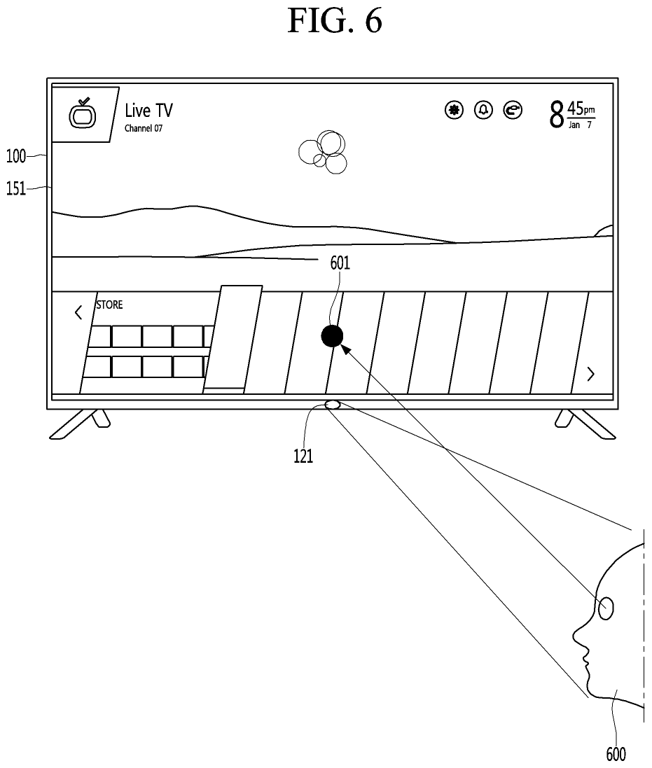

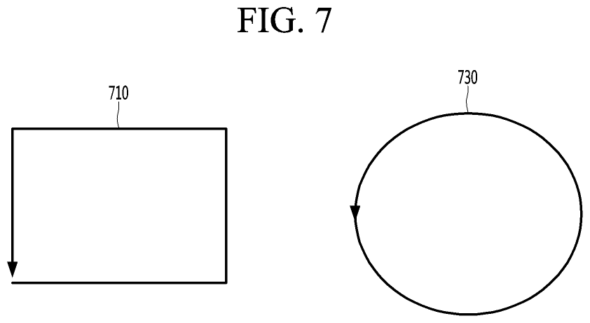

This will be described with reference to FIGS. 6 and 7.

FIGS. 6 and 7 are views illustrating a process of grasping movement of a user's gaze at an AI device and changing an operation state of the AI device according to an embodiment of the present invention.

In the following embodiment, assume that the AI device 100 is a TV.

Referring to FIG. 6, a user is located in front of the AI device 100 and the user is looking at the front surface of the display unit 151 of the AI device 100.

The camera 121 of the AI device 100 may acquire a user image.

The processor 180 may extract the eye image of the user from the acquired user image. The processor 180 may grasp the gaze direction of the user from the extracted eye image.

The processor 180 may set the gaze position of the user as a reference position 601 when the left pupil or the right pupil included in the eye image is fixed.

The processor 180 may grasp the movement of the left pupil or the right pupil as movement of the user's gaze and determine whether the movement of the user's gaze matches a predetermined gaze movement pattern.

FIG. 7 shows an example of predetermined gaze movement patterns.

A first gaze movement pattern 710 refers to a pattern in which the gaze moves in a rectangular path.

A second gaze movement pattern 720 refers to a pattern in which the gaze moves in a circular path.

The predetermined gaze movement patterns shown in FIG. 7 are merely examples and patterns having various shapes may be set.

The processor 180 may output the same effect as recognition of the startup command when the first gaze movement pattern 710 or the second gaze movement pattern 730 is detected.

That is, the processor 180 may change the operation state of the AI device 100 from the inactive state to the active state according to recognition of startup gaze movement such as the first and second gaze movement pattern 710 or 730.

Meanwhile, the processor 180 may release the active state of the AI device 100, when startup gaze movement is recognized again after startup gaze movement is recognized to activate the AI device 100.

That is, the processor 180 may change the active state of the AI device 100 to the inactive state, when the startup gaze movement is recognized again.

FIG. 5 will be described again.

In another example, the processor 180 may change the operation state of the AI device 100 to the active state, when the user gesture matches a predetermined gesture stored in the memory 170.

Meanwhile, the processor 180 maintains the operation state of the AI device 100 in the inactive state when the first user action information is not the predetermined user action information (S507).

The processor 180 may not change the AI device 100 to the active state when the grasped user's gaze movement does not match the gaze movement pattern stored in the memory 170.

The processor 180 acquires a position corresponding to the user's gaze in the active state (S509), and displays a cursor at the acquired position through the display unit 151 (S511).

The processor 180 may acquire the position corresponding to the user's gaze based on the acquired user image in the active state.

The processor 180 may track the user's gaze using a known gaze tracking method.

The position corresponding to the user's gaze may be a point, to which the user's gaze is directed, on the front surface of the display unit 151. The point to which the user's gaze is directed may be represented by gaze coordinates.

The gaze coordinates may indicate the position of the gaze on the front surface of the display unit 151 based on the position of the camera 121.

The processor 180 may display the cursor at the position, to which the user's gaze is directed, through the display unit 151.

The cursor may be a moving object in correspondence with movement of the user's gaze.

The cursor may have a circular or an arrow shape, but this is merely an example.

Thereafter, the processor 180 acquires second user action information (S513), and selects an item corresponding to the position of the cursor according to the acquired second user action information (S515).

The second user action information may be used to select one or more of a plurality of items displayed on the display unit 151 through the cursor.

The plurality of items may be menu items for controlling operation of the AI device 100.

The second user action information may be information indicating eyeblink.

The processor 180 may recognize eyeblink from the user image acquired through the camera 121.

The processor 180 may select an item on which the cursor is located, as eyeblink is recognized.

In another example, the second user action information may be information indicating a user gesture.

The processor 180 may recognize a specific user gesture or gesture change from the user image acquired through the camera 121.

The processor 180 may select an item on which the cursor is located, as the recognized specific gesture or gesture change is detected.

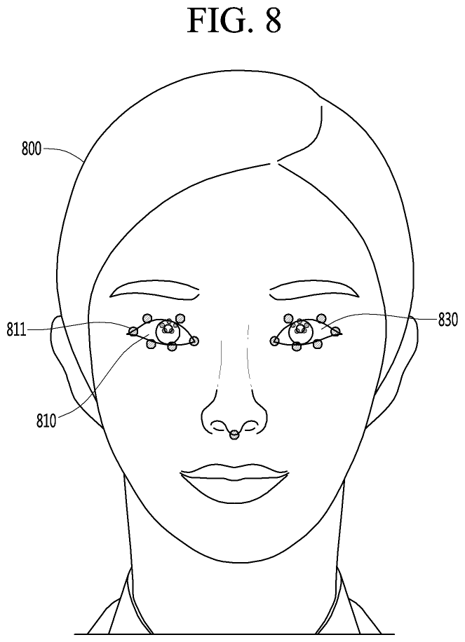

FIGS. 8 to 11 are views illustrating an example of selecting an item corresponding to a cursor according to second user action information according to an embodiment of the present invention.

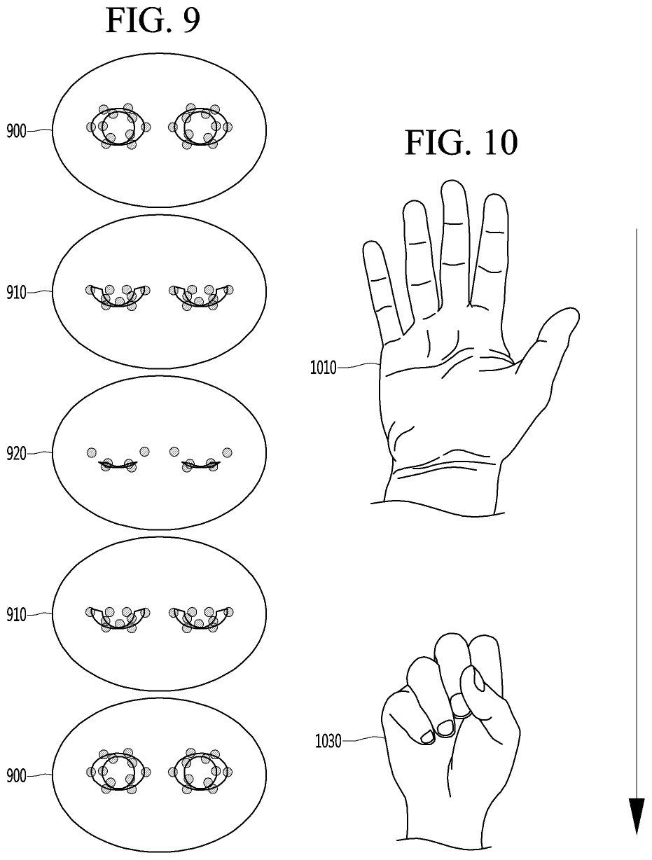

In particular, FIGS. 8 and 9 are views illustrating a process of recognizing eyeblink of the user and FIG. 10 is a view illustrating a process of recognizing a gesture of a user.

First, referring to FIG. 8, a user face image 800 is shown.

The processor 180 may extract a right eye image 810 and a left eye image 830 from the user face image 800.

The processor 180 may extract the right eye image 810 and the left eye image 830 from the user face image 800 using a known feature point extraction method.

The processor 180 may extract landmarks 811 indicating the features of the eye from the right eye image 810 and the left eye image 830.

The landmarks 811 may be located on the outline, pupil, iris and eyelid of the eye.

The processor 180 may recognize eyeblink of the user using the landmarks 811.

This will be described in detail with reference to FIG. 9.

Referring to FIG. 9, states indicating eyeblink are sequentially shown.

Eyeblink includes a process of changing the state in order of a first state 900 in which the eye is completely opened, a second state 910 in which the eye is half-closed, and a third state 920 in which the eye is closed, the second state 910 and the first state 900.

The processor 180 may recognize eyeblink based on change in the landmarks included in the right eye image and the left eye image.

Specifically, the number of landmarks is largest in the first state 900, is reduced in the second state 910 as compared to the first state 900, and is further reduced in the third state 920 as compared to the second state 910.

Thereafter, the processor 180 may recognize that the user's eyes are opened again based on the number of landmarks acquired in each of the second state 910 and the first state 900.

The processor 180 may recognize eyeblink using the landmarks indicating the features of the left eye image and the right eye image.

The processor 180 may select a menu item corresponding to the position of the cursor as eyeblink is recognized.

According to another embodiment of the present invention, the second user action information may be detected through a user gesture.

Referring to FIG. 10, a first gesture 1010 and a second gesture 1030 are shown.

The processor 180 may sequentially acquire a first gesture image corresponding to the first gesture 1010 and a second gesture image corresponding to the second gesture 1030 through the camera 121.

The processor 180 may determine whether two sequential gesture images prestored in the memory 170 match the first and second gesture images.

The two gesture images prestored in the memory 170 may be set by the user or by default.

The processor 180 may determine that the second user action information is detected, when the sequentially acquired first and second gesture images match the two sequential gesture images stored in the memory 170.

Thereafter, the processor 180 may select a menu item corresponding to the position of the cursor.

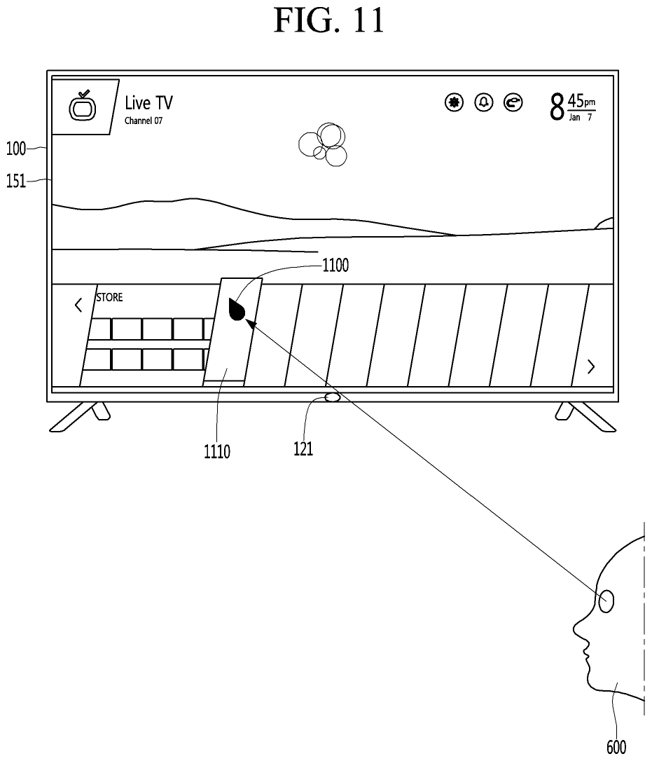

FIG. 11 shows a cursor 1100 displayed on the display unit 151 of the AI device 100 in correspondence with the gaze direction of the user.

In FIG. 11, the operation state of the AI device 100 is in the active state.

The processor 180 may continuously capture the image of the user through the camera 121 and grasp movement of the user's gaze from the captured image.

The cursor 1100 may move in the movement direction of the user's gaze.

The processor 180 may recognize eyeblink in a state in which the cursor 1100 is located on the menu item 1110.

The processor 180 may select the menu item 1100 corresponding to the position of the cursor 1100 when eyeblink of the user is recognized.

The processor 180 may interpret the eyeblink of the user as a command for selecting the menu item 1100.

A program related to the menu item 1100 may be executed or a separate menu window may be displayed according to selection of the menu item 1100.

According to the embodiment of the present invention, when the user cannot issue a voice command, it is possible to easily control operation of the AI device 100 using the gaze or gesture of the user.

That is, the user can smoothly select a desired menu, thereby significantly improving user convenience.

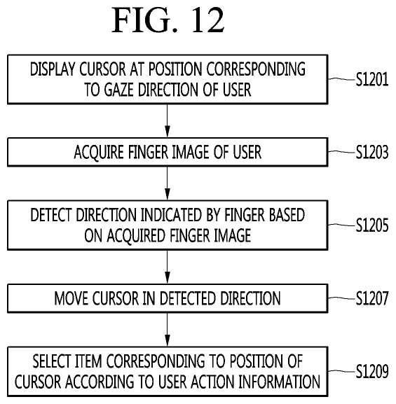

FIG. 12 is a flowchart illustrating a method of operating an AI device according to another embodiment of the present invention.

In particular, FIG. 12 relates to an embodiment in which movement of a cursor is controlled according to movement of a user's finger after the cursor is displayed in the gaze direction of the user.

In FIG. 12, the operation state of the AI device 100 is in the active state.

Referring to FIG. 12, the processor 180 displays the cursor corresponding to the gaze direction of the user through the display unit 151 (S1201).

To this end, steps S501 to S509 of FIG. 5 may be performed in advance.

The processor 180 acquires the image of the user's finger through the camera 121 (S1203), and detect a direction indicated by the finger based on the acquired image of the finger (S1205).

That is, after the cursor is displayed, movement of the cursor may be determined by movement of the user's finger.

The processor 180 may switch the movement control of the cursor from the user's gaze to the finger when a finger image or a moving finger image is detected.

The processor 180 may switch the movement control of the cursor from the user's gaze to the finger, when a position to which a fingertip is directed matches the position to which the user's gaze is directed.

The processor 180 may detect a direction indicated by the fingertip from the finger image.

The processor 180 moves the position of the cursor in the detected direction (S1207).

The processor 180 may detect the movement direction of the finger and move the position of the cursor in the detected direction.

The processor 180 selects an item corresponding to the position of the cursor moved according to user action information (S1209).

Here, the user action information may be the second user action information described with reference to FIG. 5. That is, the user action information may indicate eyeblink.

The processor 180 may select the item corresponding to the position of the cursor according to the user action information and display a menu window related to the selected item or execute an application corresponding to the selected item.

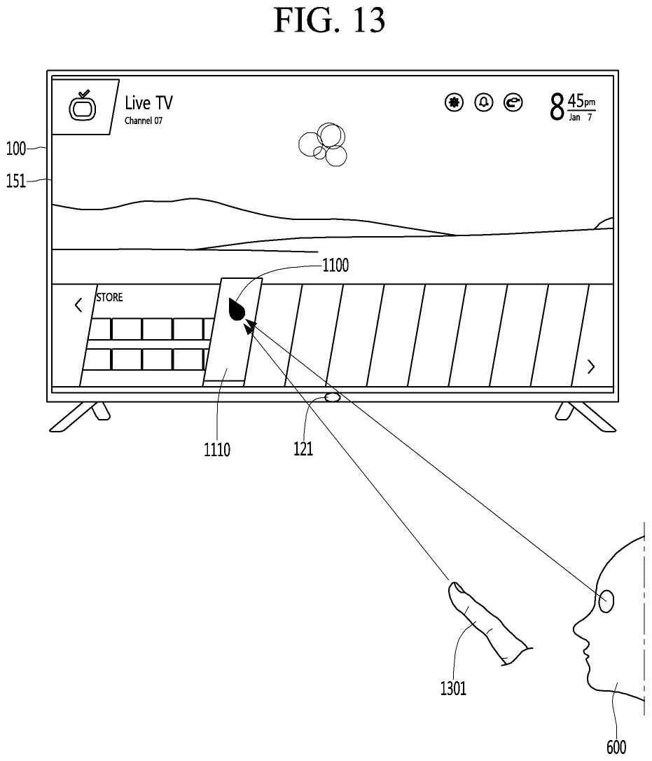

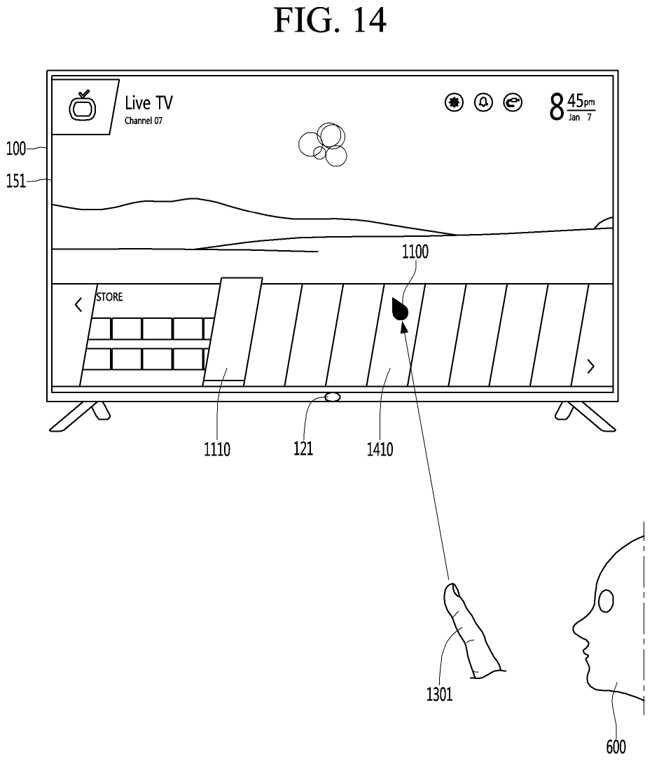

FIG. 12 will be described with reference to FIGS. 13 and 14.

FIGS. 13 and 14 are views illustrating an example of controlling movement of a cursor according to movement of a user's finger.

Referring to FIG. 13, a cursor 1100 is displayed at a position, to which the user's gaze is directed, on the display unit 151 of the AI device 100.

The processor 180 may acquire the finger image of the user through the camera 121 and acquire the position indicated by the finger 1301 from the finger image.

The processor 180 may determine that the movement control of the cursor 1100 is switched from the user's gaze to the finger 1301, when the position to which the tip of the finger 1301 is directed matches the position to which the gaze is directed.

As shown in FIG. 14, the processor 180 may detect the movement direction of the finger 1310 and move the cursor 1100 in the detected movement direction.

The processor 180 may execute an application corresponding to an application item 1410 when the cursor 1100 is located on the application item 1310 and eyeblink is recognized.

According to the embodiment of the present invention, when the user cannot issue the voice command, it is possible to conveniently control operation of the AI device 100 using the gaze, finger movement and eyeblink of the user.

According to the embodiment of the present invention, it is possible to easily control operation of the AI device using a user's gaze or gesture when a user cannot issue a voice command.

That is, the user can smoothly select a desired menu, thereby significantly improving user convenience.

The present invention mentioned in the foregoing description can also be embodied as computer readable codes on a computer-readable recording medium. Examples of possible computer-readable mediums include HDD (Hard Disk Drive), SSD (Solid State Disk), SDD (Silicon Disk Drive), ROM, RAM, CD-ROM, a magnetic tape, a floppy disk, an optical data storage device, etc. The computer may include the controller 180 of the AI device.

What is claimed is:

1. An artificial intelligence device capable of being controlled according to user action, the artificial intelligence device comprising:
a display;
a camera configured to capture an image of a user; and
a processor configured to:
acquire first user action information based on the captured image,
change an operation state of the artificial intelligence device from an inactive state to an active state when the acquired first user action information is predetermined action information,
display a cursor at a position corresponding to a gaze of the user through the display based on the captured image,
acquire second user action information, and
select an item corresponding to the position of the cursor based on the acquired second user action information.

2. The artificial intelligence device of claim 1, wherein the first user action information is any one of information on movement of the gaze of the user or information on a gesture of the user.

3. The artificial intelligence device of claim 2, wherein the processor changes the artificial intelligence device to the active state when movement of the gaze of the user matches a predetermined gaze movement pattern.

4. The artificial intelligence device of claim 2, wherein the processor changes the artificial intelligence device to the active state when the gesture of the user matches a predetermined gesture.

5. The artificial intelligence device of claim 1, wherein the second user action information indicates eyeblink of the user.

6. The artificial intelligence device of claim 1, further comprising a microphone,
wherein the processor outputs a notification indicating that provision of a voice recognition service is impossible when a level of ambient noise measured through the microphone is equal to or greater than a predetermined level.

7. The artificial intelligence device of claim 1, wherein the processor moves the cursor in a movement direction of the gaze of the user.

8. A method of operating an artificial intelligence device capable of being controlled according to user action, the method comprising:
capturing an image of a user;
acquiring first user action information based on the captured image;
changing an operation state of the artificial intelligence device from an inactive state to an active state when the acquired first user action information is predetermined action information;
displaying a cursor at a position corresponding to a gaze of the user through a display based on the captured image; and
acquiring second user action information and selecting an item corresponding to the position of the cursor based on the acquired second user action information.

9. The method of claim 8, wherein the first user action information is any one of information on movement of the gaze of the user or information on a gesture of the user.

10. The method of claim 9, wherein the changing includes changing the artificial intelligence device to the active state when movement of the gaze of the user matches a predetermined gaze movement pattern.

11. The method of claim 9, wherein the changing includes changing the artificial intelligence device to the active state when the gesture of the user matches a predetermined gesture.

12. The method of claim 8, wherein the second user action information indicates eyeblink of the user.

13. The method of claim 8, further comprising outputting a notification indicating that provision of a voice recognition service is impossible, when a level of ambient noise is equal to or greater than a predetermined level.

14. The method of claim 8, further comprising moving the cursor in a movement direction of the gaze of the user.
